(19) United States
(12) Patent Application Publication
(10) Pub. No.: US 2020/0063638 A1
(43) Pub. Date: Feb. 27, 2020

(54) PRESSURE ADJUSTABLE RADIATOR CAP

(71) Applicant: Hsi-Chang LEE, Changhua (TW)

(72) Inventor: Hsi-Chang LEE, Changhua (TW)

(21) Appl. No.: 16/111,149

(22) Filed: Aug. 23, 2018

(51) Int. Cl. F01P 11/02

(52) U.S. Cl. CPC F01P 11/0238; B60K 11/02

(57) ABSTRACT

A pressure adjustable radiator cap contains: a body screwed with a pressure adjustment assembly connected with a covering assembly. The pressure adjustment assembly includes a rotatable knob, an adjusting bolt, a push spring, and a holder. The covering assembly includes a rubber gasket, a lid, a positioning spring, and a coupling sleeve. The pressure adjustment assembly abuts against the push spring by using of a connection disc on a lower end of the adjusting bolt, and the riveting portion on the lower end of the adjusting bolt contacts with the coupling sleeve so that the pressure adjustment assembly is connected with the covering assembly. The rotatable knob is rotated to actuate the adjusting bolt to revolve so as to change a screwing force between the adjusting bolt and the body, thus adjust a closing pressure of the covering assembly to water inlet of a water tank.

### FIELD OF THE INVENTION

The present invention relates to a pressure adjustable radiator cap which is capable of enhancing tightness and pressure to a water inlet of a water tank.

### BACKGROUND OF THE INVENTION

A radiator cap for vehicles contains a body and an auxiliary cushion assembly which are riveted together, and a seal cushion assembly housed in the body. Each of the auxiliary cushion assembly and the seal cushion assembly has a spring for pushing related components of the body, such that the body is sealed securely to avoid spraying vapors and boiling water because of high temperature and pressure.

However, the springs of the auxiliary cushion assembly and the seal cushion assembly cause fatigue after a period of using time in the high pressure, so the body is not sealed matingly. Furthermore, the springs cannot be replaced since the body and the auxiliary cushion assembly cannot be removable after being riveted together.

In addition, specification tolerances of different water tanks exist, so the body cannot be locked tightly to have water leakage. In order to enhance operation efficiency of the engine, a pressure value of the body has to be increased. But the body has a fixed pressure value, so it has to be refitted to suitable pressure value, thus having high refitting cost.

The present invention has arisen to mitigate and/or obviate the afore-described disadvantages.

### SUMMARY OF THE INVENTION

The primary aspect of the present invention is to provide a pressure adjustable radiator cap which is capable of enhancing tightness and pressure to a water inlet of a water tank because of fatigue or specification tolerance of the push spring and the second rubber gasket.

Another aspect of the present invention is to provide a pressure adjustable radiator cap which is capable of enhancing the operating efficiency of the engine by pressurizing the water tank.

To obtain the above aspect, a pressure adjustable radiator cap provided by the present invention contains: a body, a center of which is screwed with a pressure adjustment assembly, and a lower end of the pressure adjustment assembly is connected with a covering assembly.

The pressure adjustment assembly includes a rotatable knob, an adjusting bolt, a push spring, and a holder; the covering assembly includes a rubber gasket, a lid, a positioning spring, and a coupling sleeve.

The pressure adjustment assembly abuts against the push spring by using of a connection disc on a lower end of the adjusting bolt, and the riveting portion on the lower end of the adjusting bolt contacts with the coupling sleeve so that the pressure adjustment assembly is connected with the covering assembly, wherein the rotatable knob is rotated to actuate the adjusting bolt to revolve so as to change a screwing force between the adjusting bolt and the body, such that the connection disc of the adjusting bolt abuts against the push spring by using different forces, and the push spring pushes the holder, the lid, and the rubber gasket in difference pushing forces so as to adjust a closing pressure of the covering assembly to water inlet of a water tank

Accordingly, when the push spring and the second rubber gasket cause fatigue or a pressure value of the body is adjusted, the rotatable knob is rotated to actuate the adjusting bolt, by which a pushing force of the push spring to the holder and the washer is adjustable, thus obtaining operation safety.

### BRIEF DESCRIPTION OF THE DRAWINGS

FIG. 1 is a perspective view showing the assembly of a pressure adjustable radiator cap according to a preferred embodiment of the present invention.

FIG. 2 is a perspective view showing the exploded components of the pressure adjustable radiator cap according to the preferred embodiment of the present invention.

FIG. 3 is a cross sectional view showing the assembly of the pressure adjustable radiator cap according to the preferred embodiment of the present invention.

FIG. 4 is a perspective view showing the assembly of a part of the pressure adjustable radiator cap according to the preferred embodiment of the present invention.

FIG. 5 is a cross sectional view showing the assembly of a part of the pressure adjustable radiator cap according to the preferred embodiment of the present invention.

FIG. 6 is a cross sectional view showing the operation of the pressure adjustable radiator cap according to the preferred embodiment of the present invention.

FIG. 7 is a top plan view showing the operation of the pressure adjustable radiator cap according to the preferred embodiment of the present invention.

FIG. 8 is another cross sectional view showing the operation of the pressure adjustable radiator cap according to the preferred embodiment of the present invention.

FIG. 9 is also another cross sectional view showing the operation of the pressure adjustable radiator cap according to the preferred embodiment of the present invention.

### DETAILED DESCRIPTION OF THE PREFERRED EMBODIMENTS

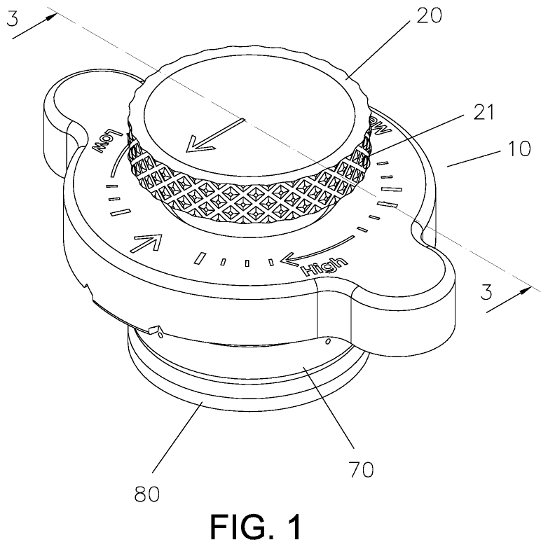

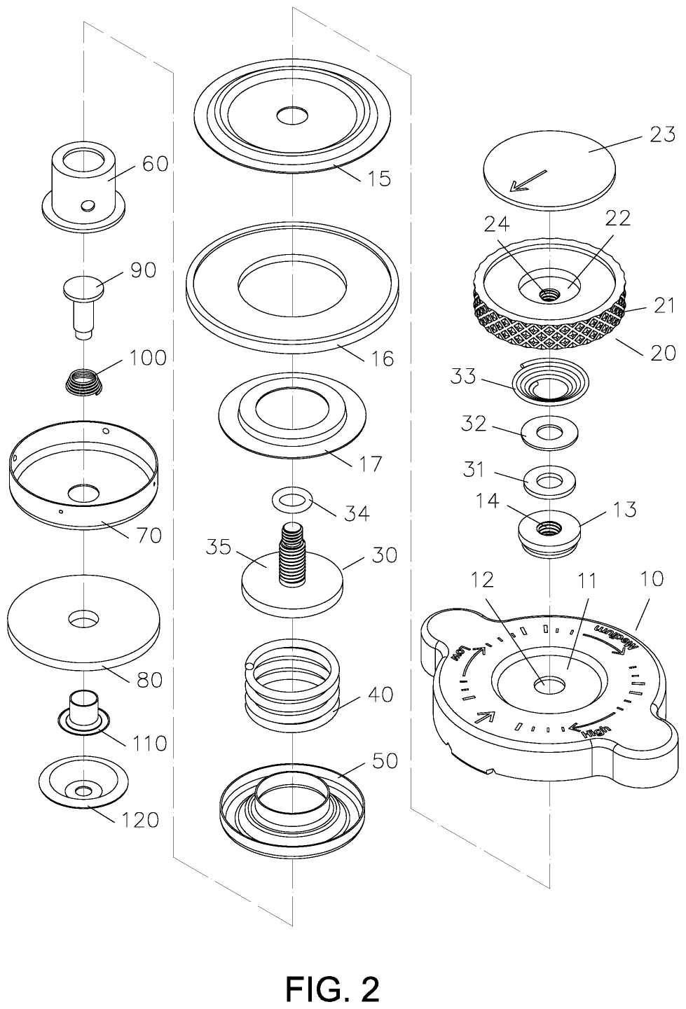

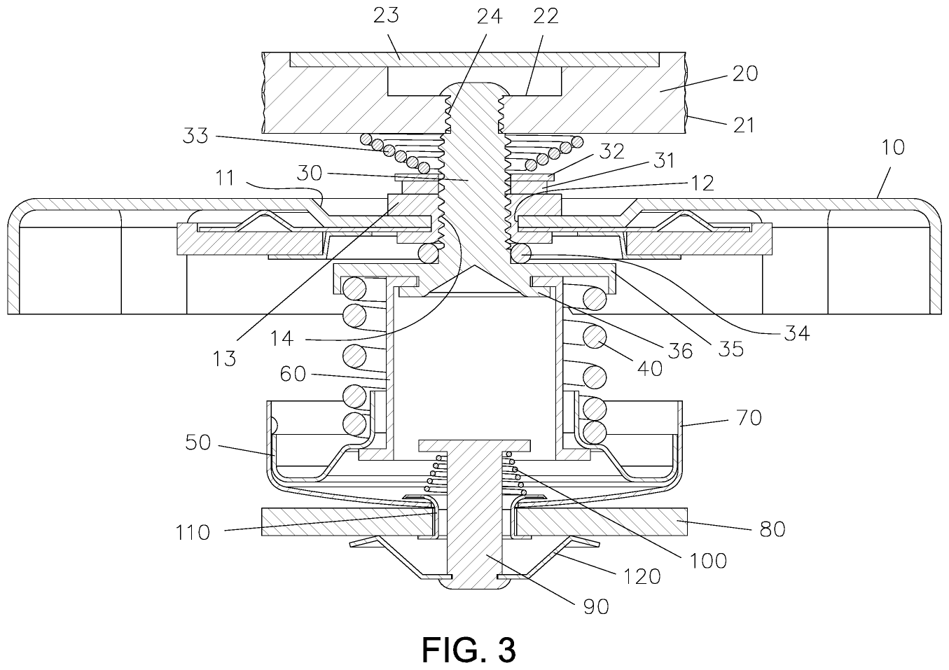

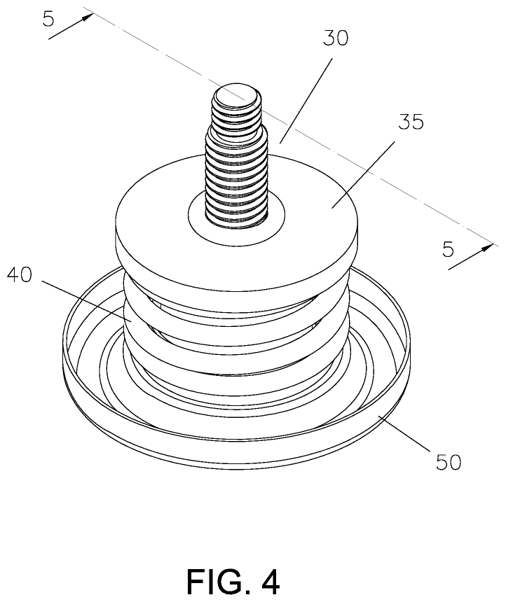

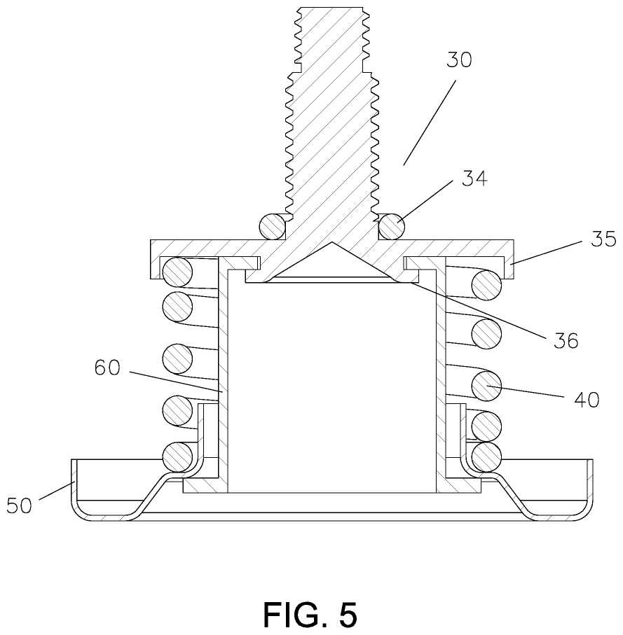

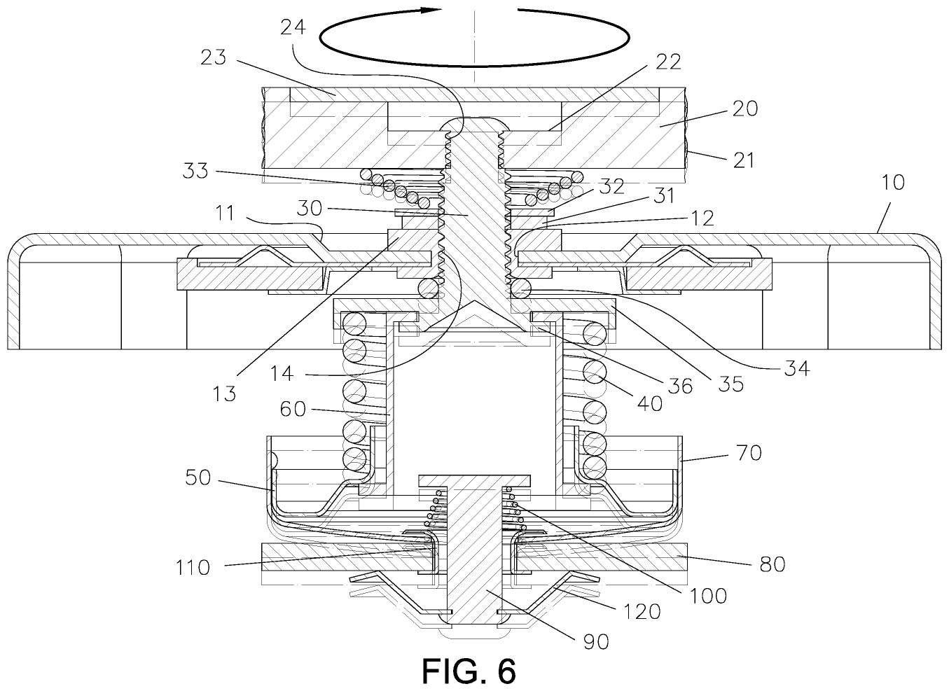

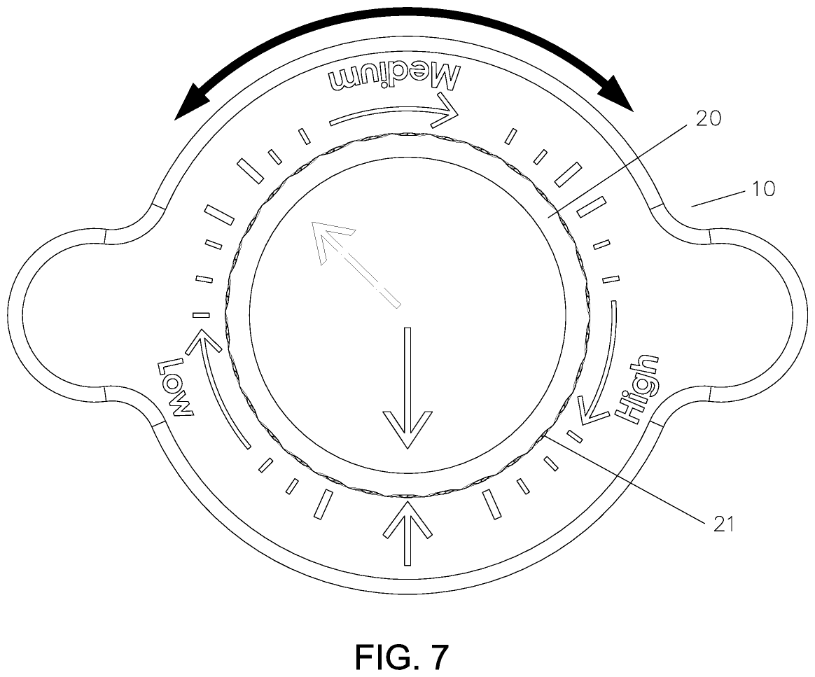

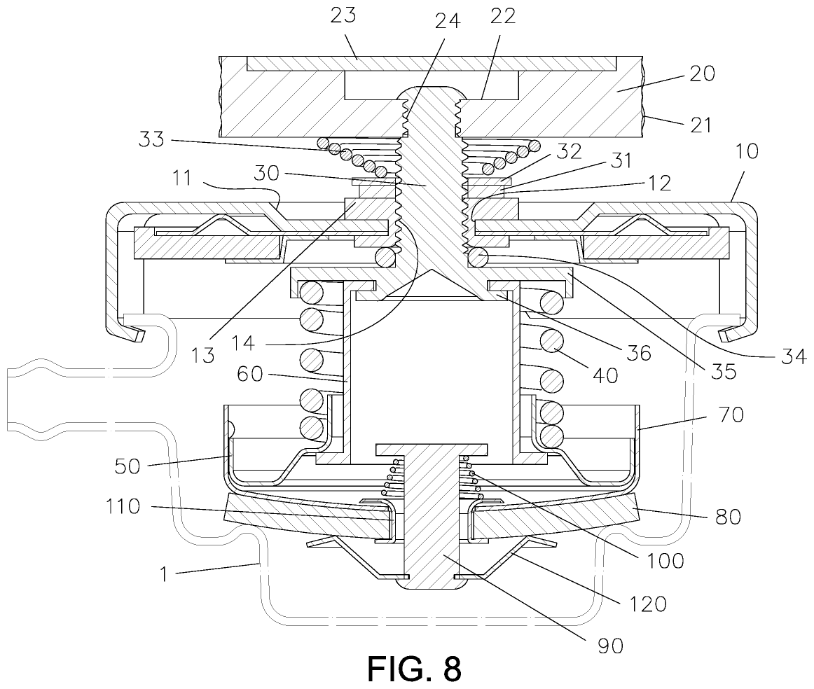

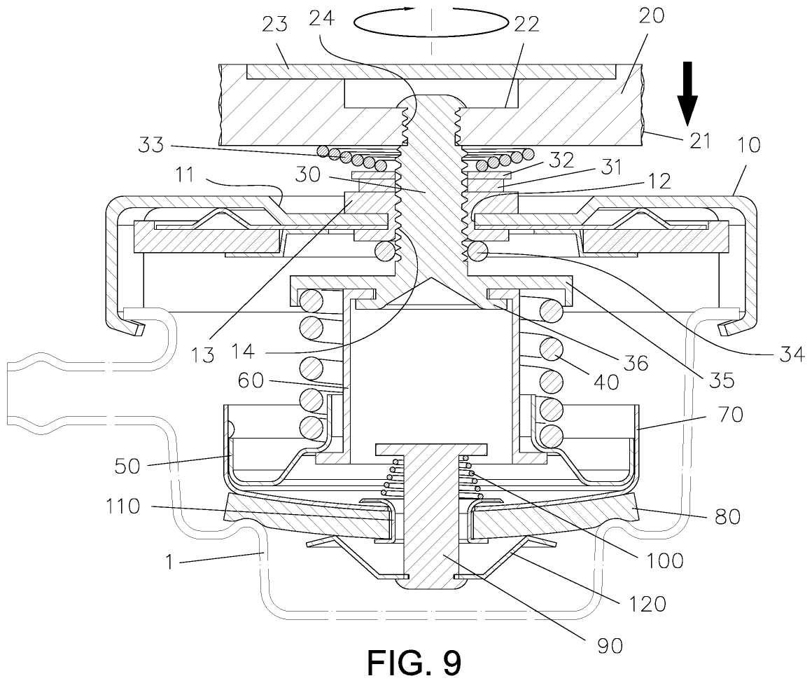

With reference to FIGS. 1-9, a pressure adjustable radiator cap according to a preferred embodiment of the present invention comprises:

a body 10 including a groove 11 defined on a top of the body 10, a through orifice 12 formed on a center of the groove 11 so as to rivet with a threaded sleeve 13, wherein the threaded sleeve 13 has a first threaded orifice 14 formed in a center thereof and is riveted with a fixing gasket 15, a first rubber gasket 16, and a defining gasket 17 so as to form a seal cushion assembly inside an inner rim of the top of the body 10, wherein the body 10 further includes multiple letters and numbers marked on the top thereof so as to indicate pressure adjustment and direction;

a pressure adjustment assembly including a rotatable knob 20, an adjusting bolt 30, a push spring 40, and a holder 50, wherein the rotatable knob 20 has embossing patterns 21 formed around a peripheral wall thereof so as to enhance secure touch, a notch 22 defined on a top of the rotatable knob 20, an indication cover 23 covering the notch 22 of the rotatable knob 20 so as to match with the multiple letters and numbers of the body 10, and a second threaded orifice 24 formed on a center of the notch 21, such that the adjusting bolt 30 is screwed and riveted with the second threaded orifice 24 of the rotatable knob 20 after being inserted through a plastic gasket 31, a washer 32, and a compression spring 33 from the first threaded orifice 14 of the threaded sleeve 13 of the body 10 so that the rotatable knob 20 is rotated to drive the adjusting bolt 30 to revolve, wherein the adjusting bolt 30 includes a seal ring 34 fitted on a base thereof, a connection disc 35 and a riveting portion 36 which are both formed on a lower end of the adjusting bolt 30, wherein the riveting portion 36 is riveted with a coupling sleeve 60 of a covering assembly, the push spring 40 is fitted on the coupling sleeve 60, and the holder 50 is connected on a lower portion of the coupling sleeve 60; and

the covering assembly including the coupling sleeve 60, a lid 70, a second rubber gasket 80, a fixer 90, a positioning spring 100, a fitting bolt 110, and an affix sheet 120, wherein the coupling sleeve 60 is inserted through the holder 50 to rivet with the riveting portion 36 of the adjusting bolt 30, the lid 70 covers the holder 50, and the fixer 90 is inserted through and is riveted with the positioning spring 100, the lid 70, the second rubber gasket 80, the fitting bolt 110, and the affix sheet 120.

When the body 10 is covered on a water inlet 1 of a water tank, the push spring 40 pushes the holder 50, the lid 70, and the second rubber gasket 80 so that the second rubber gasket 80 matingly contacts with the water inlet 1. In the meantime, a pushing force of the push spring 40 is set at a predetermined value based on a specification of the pressure adjustable radiator cap. When the second rubber gasket 80 or the push spring 40 causes fatigue after a period of using time or the water tank is pressurized to enhance operating efficiency of engine, the rotatable knob 20 is rotated to actuate the adjusting bolt 30 to revolve, hence a screwing force between the adjusting bolt 30 and the body 10 is changed so that the connection disc 35 of the adjusting bolt 30 abuts against the push spring 40 by using different forces, and the push spring 40 pushes the holder 50, the lid 70, and the second rubber gasket 80 in difference pushing forces so as to adjust a closing pressure of the covering assembly to water inlet 1, thus avoiding poor tightness and water leakage because of the fatigue of the push spring 40 and the second rubber gasket 80. Preferably, the operating efficiency of the engine is enhanced by pressurizing the water tank.

Accordingly, when the poor tightness and the water leakage occur because of the fatigue or specification tolerance of the push spring and the second rubber gasket, the rotatable knob is rotated to actuate the adjusting bolt to change the screwing force between the adjusting bolt and the body and to adjust the pushing force of the push spring for pushing the holder, the lid 70, and the second rubber gasket, thus maintaining tightness of the body and the water inlet. Preferably, as desiring to enhance the operating efficiency of the engine by pressurizing the water tank, the rotatable knob is rotated to actuate the adjusting bolt to adjust the screwing force between the adjusting bolt and the body, and the push spring adjusts the closing pressure of the covering assembly, thus enhancing the operating efficiency of the engine and eliminating purchase cost of different specifications of the bodies.

Thereby, the rotatable knob is rotated to actuate the adjusting bolt to revolve and to change the screwing force between the adjusting bolt and the body without a removal of the body, such that the connection disc of the adjusting bolt abuts against the push spring by using different forces, and the push spring pushes the holder and the second rubber gasket in difference pushing forces so as to adjust the closing pressure of the covering assembly to water inlet, thus avoiding the poor tightness and the water leakage because of the fatigue or the specification tolerance of the push spring and the second rubber gasket. Preferably, the operating efficiency of the engine is enhanced by pressurizing the water tank.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A pressure adjustable radiator cap comprising: a body, a center of which is screwed with a pressure adjustment assembly, and a lower end of the pressure adjustment assembly being connected with a covering assembly;
wherein the pressure adjustment assembly includes a rotatable knob, an adjusting bolt, a push spring, and a holder; the covering assembly includes a rubber gasket, a lid, a positioning spring, and a coupling sleeve;
wherein the pressure adjustment assembly abuts against the push spring by using of a connection disc on a lower end of the adjusting bolt, and the riveting portion on the lower end of the adjusting bolt contacts with the coupling sleeve so that the pressure adjustment assembly is connected with the covering assembly, wherein the rotatable knob is rotated to actuate the adjusting bolt to revolve so as to change a screwing force between the adjusting bolt and the body, such that the connection disc of the adjusting bolt abuts against the push spring by using different forces, and the push spring pushes the holder, the lid, and the rubber gasket in difference pushing forces so as to adjust a closing pressure of the covering assembly to water inlet of a water tank.

2. The pressure adjustable radiator cap as claimed in claim 1, wherein the body including a threaded sleeve which has a first threaded orifice formed in a center of the threaded sleeve so as to screw and rivet with the adjusting bolt of the pressure adjustment assembly.

3. The pressure adjustable radiator cap as claimed in claim 1, wherein the adjusting bolt of the pressure adjustment assembly is screwed and riveted with the rotatable knob after being inserted through a plastic gasket, a washer, and a compression spring from the body, such that the adjusting bolt is actuated by the rotatable knob to revolve.

4. The pressure adjustable radiator cap as claimed in claim 1, wherein the body further includes multiple letters and numbers marked on a top thereof so as to indicate pressure adjustment and direction; and the rotatable knob further includes a notch defined on a top thereof and an indication cover covering the notch of the rotatable knob so as to match with the multiple letters and numbers of the body, thus distinguish a pressure adjustment of the pressure adjustable radiator cap.

5. The pressure adjustable radiator cap as claimed in claim 1, wherein the rotatable knob has embossing patterns formed around a peripheral wall thereof so as to enhance secure touch.
